(19) United States
(12) Patent Application Publication
(10) Pub. No.: US 2008/0309686 A1
(43) Pub. Date: Dec. 18, 2008

(54) Display Device

(75) Inventors: Kenta Endo, Mobara (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/135,330

(22) Filed: Jun. 9, 2008

(30) Foreign Application Priority Data
Jun. 12, 2007 (JP) 2007-154858

(51) Int. Cl. G09G 5/00

(52) U.S. Cl. 345/690; 345/211

(57) ABSTRACT

To reduce heating value of the drain driver in a display device applying an FBI drive method. In a display device applying the FBI drive method in which each subpixel displays one gray scale required by an external system by displaying two gray scales which are a gray scale corresponding to first display data during one frame period of continuous two frame periods and a gray scale corresponding to second display data during the other frame period of the continuous two frame periods, and the luminance according to the second display data is lower than the luminance according to the first display data when the display data inputted from the external system is in a halftone gray scale, the power supply circuit supplies high-potential first power supply voltage to the driver during the first frame period and supplies low-potential first power supply voltage having the potential lower than the high-potential first power supply voltage during the second frame period.

The present application claims priority from Japanese application JP2007-154858 filed on Jun. 12, 2007, the content of which is hereby incorporated by reference into this application.

### BACKGROUND OF THE INVENTION

1. Field of the Invention

The invention relates to a hold-type display device such as a liquid crystal display device or an organic EL (Electro Luminescence) display, and particularly relates to a display device suitable for displaying moving pictures.

2. Background Art

A liquid crystal display module is used for a high-definition color monitor of a computer and other information devices, or for a display device of a television receiver.

The liquid crystal display module basically includes, a so-called liquid crystal display panel having a liquid crystal layer sandwiched between two (a pair of) substrates in which at least one of them is made of transparent glass or the like. Voltage is selectively applied to various types of electrodes for forming subpixels formed on the substrate of the liquid crystal display panel to thereby turn on and turn off prescribed subpixels.

In the liquid crystal display module, good display quality without flickering can be obtained in the case of still pictures, on the other hand, there is a problem that a so-called moving picture blur occurs in the case of moving pictures, in which the periphery of a moving object is blurred.

The occurrence of moving picture blur is caused by a so-called retina afterimage, in which a viewer interpolates display images before and after movement with respect to a display image whose luminance is held when the sight line moves with movement of an object, therefore, it is difficult to completely solve the moving picture blur even if the response speed of the display device is improved.

In order to solve the above problem, a method is effective, which allows the device to approximate to an impulse response-type display device by updating the display image at shorter frequency or by cancelling retina afterimage once by inserting a black screen and the like.

As the method of allowing the device to approximate to the impulse response-type display device, a method is known, in which, when a gray scale required by an external system is in a low gray scale side, the gray scale required by the external system is displayed in a pseudo manner by switching a prescribed gray scale to the minimum gray scale (hereinafter, referred to as an FBI drive method) (Refer to Patent Document 1 below).

In the FBI drive method, the gray scale required by the external system is displayed in a pseudo manner by displaying plural gray scales by each subpixel. When the gray scale required by the external system is a halftone low gray scale, at least one gray scale in plural gray scales is allowed to be the minimum gray scale (minimum luminance), and when the gray scale required by the external system is a halftone high gray scale, at least another one gray scale in plural gray scales is allowed to be the maximum gray scale (maximum luminance)

That is, when the gray scale required by the external system is in the low gray scale side, the gray scale required by the external system is displayed in a pseudo manner by switching a prescribed gray scale to the minimum gray scale.

On the other hand, when the gray scale required by the external system is in the high gray scale side, the gray scale required by the external system is displayed in a pseudo manner by switching a prescribed gray scale to the maximum gray scale.

As a related art document relating to the present application is cited as follows.

Patent Document 1: JP-A-2006-343706 (Related U.S. Patent application; US 2006-0256141A1)

In recent years, in order to reduce costs, the number of drain drivers used in a liquid crystal display module is reduced by increasing the number of outputting per one drain driver. Accordingly, there is a problem that heating value of the drain driver increases.

### SUMMARY OF THE INVENTION

The invention has been made for solving the above problem of the related art, and an object of the invention is to provide a technique capable of reducing heating value of the drain driver in the display device which applies the FBI drive method.

The summary of typical inventions in inventions disclosed in the present application will be explained briefly as follows.
(1) In a display device including a display panel having plural subpixels, a driver outputting video voltages corresponding to display data inputted from an external system to respective subpixels, and a power supply circuit supplying a first power supply voltage to the driver, in which each subpixel displays one gray scale required by the external system by displaying two gray scales which are a gray scale corresponding to first display data during one frame period of continuous two frame periods and a gray scale corresponding to second display data during the other frame period of the continuous two frame periods, the driver outputs a first video voltage corresponding to the first display data to each subpixel during one frame period of continuous two frame periods and outputs a second video voltage corresponding to the second display data to each subpixel during the other frame period of continuous two frame periods, the luminance according to the second display data is lower than the luminance according to the first display data when the display data inputted from the external system is in a halftone gray scale, and the power supply circuit supplies high-potential first power supply voltage to the driver during the first frame period and supplies low-potential first power supply voltage having the potential lower than the high-potential first power supply voltage during the second frame period.
(2) In (1), the power supply circuit includes a first terminal outputting the high-potential first power supply voltage and a second terminal outputting the low-potential first power supply voltage, and the display device further includes a selector selecting the high potential first power supply voltage outputted from the first terminal or the low-potential first power supply voltage outputted from the second terminal and supplies the voltage to the driver and a control circuit controlling the selector.
(3) In (2), the control circuit switches the selector during a vertical blanking period, changing first power supply voltage supplied to the driver to the high-potential first power supply voltage or the low-potential first power supply voltage.
(4) In (1), the display device further includes a first conversion circuit and a second conversion circuit, in which the first conversion circuit converts display data A inputted from the external system into the first display data, and the second conversion circuit converts display data B inputted from the external system into the second display data.
(5) In (4), the display data A and the display data B are the same data.
(6) In (1), when a gray scale required by the external system is included in a low gray scale side in halftone gray scales between the maximum gray scale and the minimum gray scale, the gray scale of the one frame period varies according to the gray scale required by the external system and the gray scale of the other frame period is the minimum gray scale, and when a gray scale required by the external system is included in a high gray scale side in halftone gray scales, the gray scale of the one frame period is the maximum gray scale and the gray scale in the other frame period varies according to the gray scale required by the external system.
(7) In (6), when a gray scale required by the external system is the maximum gray scale, both gray scales in the one frame period and the other frame periods are the maximum gray scales.
(8) In (6), a boundary between the low gray scale side and the high gray scale side of the gray scale required by the external system is the gray scale obtained by taking one of two gray scales in continuous two frame periods as the minimum gray scale and taking the other thereof as the maximum gray scale.

An advantage obtained by typical inventions in inventions disclosed in the present application will be briefly explained as follows.

According to the invention, it is possible to reduce heating value of the drain driver in the display device which applied the FBI drive method.

### BRIEF DESCRIPTION OF THE DRAWINGS

FIG. 1 is a block diagram showing a schematic configuration of a liquid crystal display module according to an embodiment of the invention;

FIG. 2 is a block diagram showing a schematic circuit configuration of a drain driver shown in FIG. 1;

FIG. 3 is a block diagram showing a schematic configuration of a display data conversion circuit shown in FIG. 1;

FIG. 4 is a graph showing conversion characteristics from input display data to display data for bright frames and display data for dark frames in the liquid crystal display module according to the embodiment of the invention;

FIG. 5 is a chart showing another example of a look-up table storing FBI settings value shown in FIG. 3;

FIG. 6 is a view for explaining analog power supply voltage supplied to the drain driver at the time of bright frames and analog power supply voltage supplied to the drain driver at the time of dark frames according to the embodiment of the invention; and

FIG. 7 is a diagram for explaining an example of a power supply circuit according to the embodiment of the invention.

### DESCRIPTION OF THE PREFERRED EMBODIMENT

Hereinafter, an embodiment of the invention will be explained in detail with reference to the drawings.

In all drawings for explaining the embodiment, the same numeral are put to components having the same function, and repeated explanation thereof will be omitted.

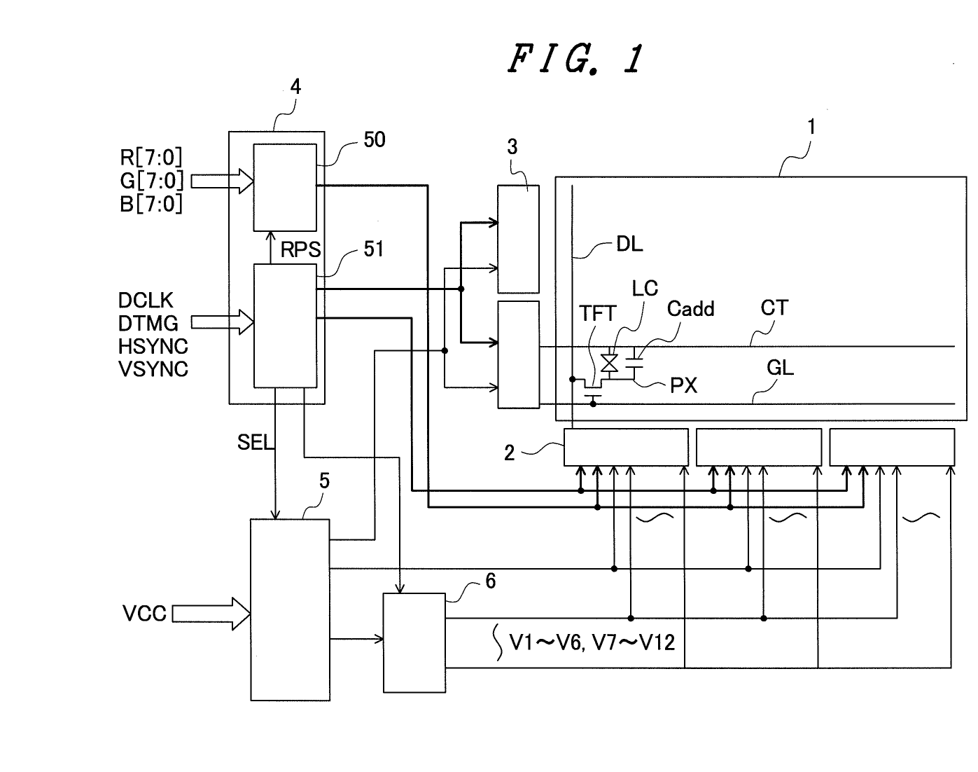

FIG. 1 is a block diagram showing a schematic configuration of a liquid crystal display module according to an embodiment of the invention. The liquid crystal display module according to the embodiment includes a liquid crystal display panel 1, drain drivers 2, gate drivers 3, a display control circuit 4, a power supply circuit 5, and a gray-scale reference voltage generating circuit 6.

The drain driver 2 includes a semiconductor chip arranged at one edge of the liquid crystal display panel 1, and the gate driver 3 includes a semiconductor chip arranged at another edge of the liquid crystal display panel 1.

The display control circuit 4 includes a display data conversion circuit 50 and a timing generating circuit 51. The timing generating circuit 51 performs timing control suitable for display of the liquid crystal panel 1 such as inversion of display data based on a dot clock (DCLK), a display timing signal (DTMG), a horizontal synchronization signal (HSYNC) and a vertical synchronization signal (VSYNC) inputted from a display signal source (host side) such as a television receiver circuit, and inputs them to the drain driver 2 and gate driver 3 with a synchronization signal (clock signal).

The gate driver 3 supplies a scanning voltage to scanning lines (GL; also referred to as gate lines) based on control of the timing generating circuit 51 of the display control circuit 4, and the drain driver 2 supplies a gray scale voltage to video lines (DL; also referred to as drain lines, source lines) to display video. The power supply circuit 5 generates various voltages required for the liquid crystal display device, and the gray-scale reference voltage generating circuit 6 generates gray scale reference voltages of V1 to V12.

In FIG. 1, TFT denotes a thin-film transistor, PX denotes a pixel electrode, CT denotes a counter electrode (common electrode), CL denotes a liquid crystal capacitor showing the liquid crystal layer equivalently, Cadd denotes a storage capacitor formed between the pixel electrode (PX) and a counter electrode (CT).

In the liquid crystal display panel 1 shown in FIG. 1, a first electrode (a drain electrode or a source electrode) of a thin-film transistor (TFT) of each subpixel arranged in a column direction is connected to a video line (DL), and each video line (DL) is connected to the drain driver 2 which supplied a gray scale voltage corresponding to display data to subpixels arranged in the column direction.

A gate electrode of the thin-film transistor (TFT) of each subpixel arranged in a row direction is connected to a scanning line (GL) respectively and each scanning line (GL) is connected to the gate driver 3 which supplies a scanning voltage (positive or negative bias voltage) to the gate of the thin-film transistor (TFT) for one horizontal scanning period.

When images are displayed on the liquid crystal display panel 1, the gate driver 3 sequentially supplies the selected scanning voltage to scanning lines GL from above to below (or from below to above), while the drain driver 2 supplies the gray scale voltage corresponding to display data to video lines (DL) during a period when the selected scanning voltage is supplied to a certain scanning line.

The voltage supplied to the video line (DL) is applied to the pixel electrode (PX) through the thin-film transistor (TFT), finally, electric charges are accumulated in the storage capacitor (Cadd) and the liquid crystal capacitor (CL) and liquid crystal molecules are controlled to display images.

In this case, assume that operation is performed in a so-called normally black-displaying mode in which the larger the gray scale voltage supplied to each subpixel is, the higher the luminance becomes.

The liquid crystal display panel 1 is formed by superimposing a first substrate (also referred to as a TFT substrate or an active-matrix substrate) on which pixel electrodes (PX), thin-film transistors (TFT), video lines (DL), scanning lines (GL) and the like are provided on a second substrate (also referred to as a counter electrode) on which color filters and the like are formed with a predetermined gap, bonding both substrates by sealant provided in a frame shape near the periphery between both substrates as well as filling liquid crystal inside the sealant between both substrates from a liquid-crystal sealing port provided at a part of the sealant and encapsulating the liquid crystal, and further, bonding a polarizing plate outside both substrates.

In addition, the counter electrodes (CT) are provided on the second substrate side in the case of a TN system or a VA system liquid crystal display panel. In the case of an IPS system, they are provided on the first substrate side.

The invention does not directly relate to the internal configuration of the liquid crystal panel, therefore, detailed explanation of the internal configuration of the liquid crystal panel is omitted. The invention can be applied to a liquid crystal panel of any configuration.

Furthermore, in an actual product, a backlight is arranged behind the liquid crystal display panel 1, however, the invention does not directly relate to the configuration of the backlight, therefore, detailed explanation of the backlight is also omitted.

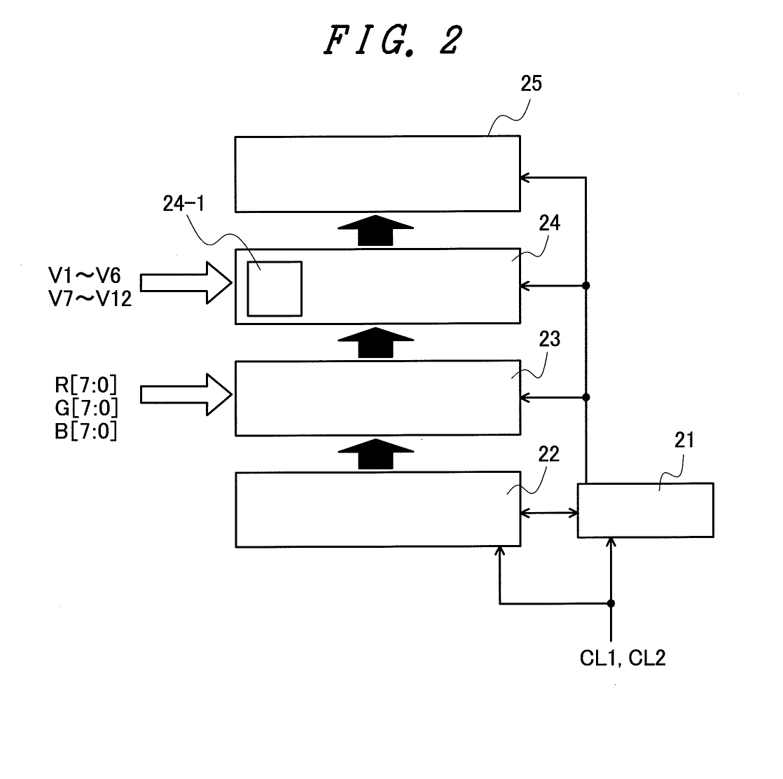

FIG. 2 is a block diagram showing a schematic circuit configuration of the drain driver 2 shown in FIG. 1.

In FIG. 2, 21 denotes a clock control unit, 22 denotes a latch address selector, 23 denotes a latch circuit, 24 denotes a D/A converter circuit and 25 denotes an output amplifier circuit.

The latch circuit 23 sequentially latches display data (R[7:0], G[7:0], B[7:0]) inputted from outside in synchronization with a clock for latching display data (CL2) outputted from the display control circuit 4 under control of the latch address selector 22.

The display data latched by the latch circuit 23 is outputted to the D/A converter circuit 24 based on a clock signal for controlling output timing (CL1) outputted from the display control circuit 4.

The D/A converter circuit 24 includes a gray-scale voltage generating circuit (24-1) generating 0 to 255 gray-scale levels of the positive polarity and the negative polarity based on V1 to V6 gray-scale reference voltages having the positive polarity and V7 to V12 gray-scale reference voltages having the negative polarity, which are inputted from the gray-scale reference voltage generating circuit 6.

The D/A converter circuit 24 selects a gray scale voltage corresponding to display data inputted from the latch circuit 23 in 0 to 255 gray-scale levels of the positive polarity and the negative polarity, which are generated in the gray-scale voltage generating circuit (24-1), inputting the voltage to the output amplifier circuit 25.

The output amplifier circuit 25 amplifies the gray scale voltage inputted from the D/A converter circuit 24 in the amplifier circuit, outputting the voltage to a corresponding video line (DL).

The liquid crystal display module of the embodiment applies the FBI drive method. Accordingly, the display control circuit 4 includes the display data conversion circuit 50.

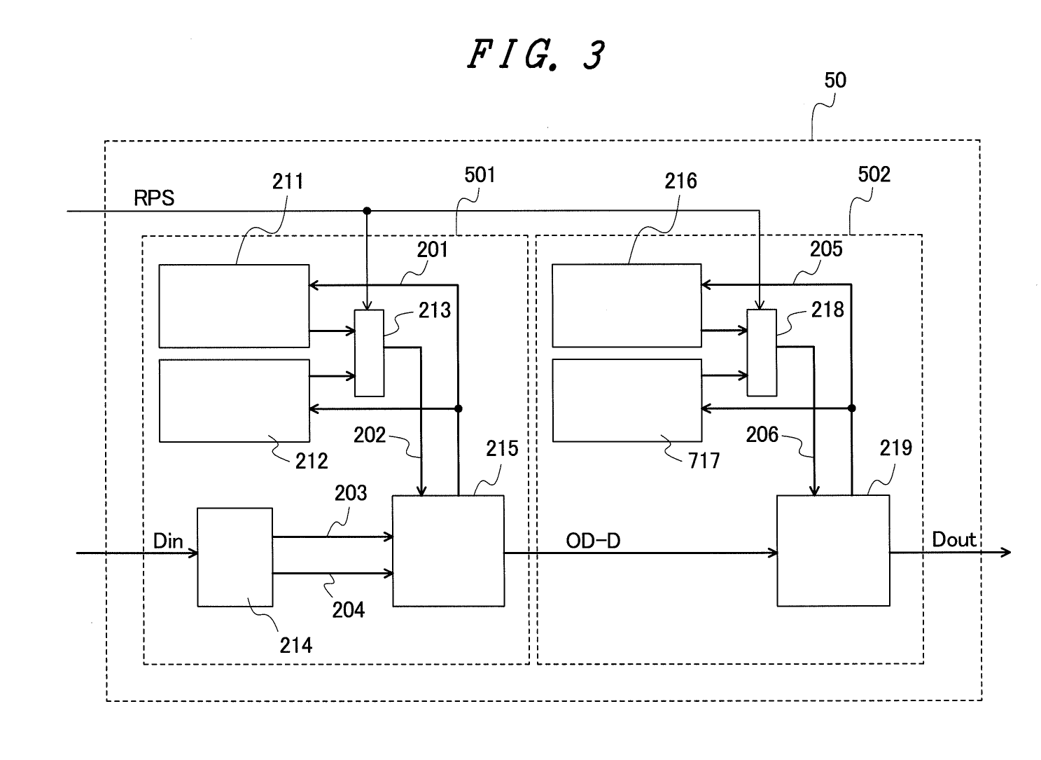

FIG. 3 is a block diagram showing a schematic configuration of the display data conversion circuit 50 shown in FIG. 1. In FIG. 3, 501 denotes an overdrive processing circuit and 502 denotes an FBI processing circuit.

The overdrive processing circuit 501 includes a look-up table 211 storing overdrive correction values for bright frames, a look-up table 212 storing overdrive correction values for dark frames, a selector 213, a memory 214, and an arithmetic circuit 215. The bright frame and the dark frame will be explained later.

In the embodiment, display data is inputted by every 60 Hz frame from outside and stored in the memory 214. The display data stored in the memory 214 is read twice to generate first display data and second display data of 120 Hz frame.

Display data 203 which is one-frame previous to a current frame and display data 204 as the current frame which are read from the memory 214 are inputted to the arithmetic circuit 215. The arithmetic circuit 215 compares the display data 203 with the display data 204 to generate a read address 201, reading overdrive correction values from the look-up table 211 and the look-up table 212.

Either one overdrive correction value 202 of the overdrive correction value read from the look-up table 211 and the overdrive correction value read from the look-up table 212 is inputted to the arithmetic circuit 215 based on the selector 213 controlled by a switching signal (RPS) outputted from the timing generating circuit 51 in the display control device 4. The arithmetic circuit 215 adds the overdrive correction value 202 to the display data 204 or subtracts the overdrive correction value 202 from the display data 204 to perform overdrive processing with respect to the display data 204 of the current frame. Actually, the overdrive processing is performed only with respect to bright frames, therefore, the correction value in the look-up table 212 will be “0”.

The FBI processing circuit 502 includes a look-up table 216 storing FBI setting values for bright frames, a look-up table 217 storing FBI setting values for dark frames, a selector 218 and an arithmetic circuit 219.

In the embodiment, display data read from the memory 214 first by every 120 Hz frame is allowed to be the first display data and display data read at the second time is allowed to be the second display data, and the first display data will be display data for bright frames and the second display data will be display data for dark frames.

The display data outputted from the arithmetic circuit 215 is inputted to the arithmetic circuit 219. The arithmetic circuit 219 reads FBI setting values 206 corresponding to display data outputted from the arithmetic circuit 215 from the look-up table 216 and the look-up table 217. Either one FBI setting value of the FBI setting value read from the look-up table 216 and the FBI setting value read from the look-up table 217 is inputted to the arithmetic circuit 219 based on the selector 218 controlled by the switching signal (RPS) to be converted to display data for the bright frame or display data for the dark frame.

Hereinafter, the FBI processing will be briefly explained.

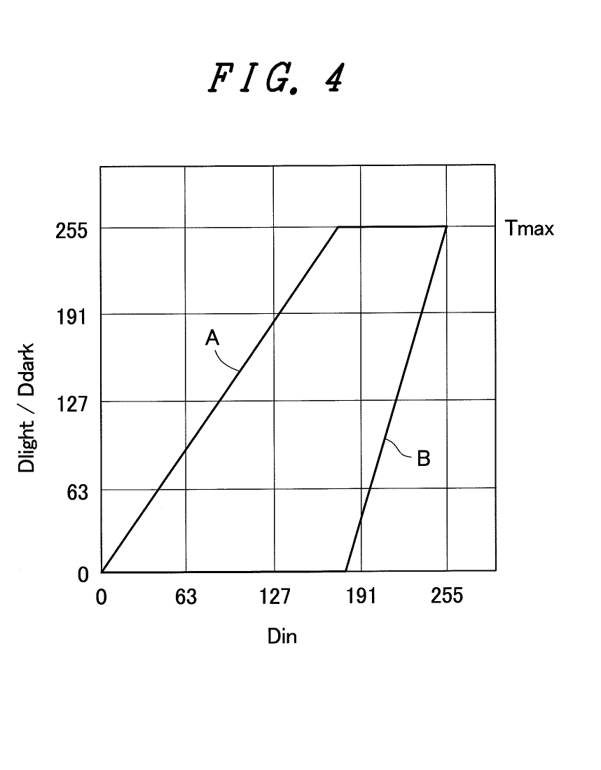

FIG. 4 is a graph showing conversion characteristics from input display data to display data for bright frames and display data for dark frames, taking input display data as a horizontal axis and display data for bright frames (Dlight) or display data for dark frames (Ddark) as a vertical axis.

In the embodiment, frames in which images are displayed according to display data to which conversion characteristics shown by “A” in FIG. 4 are performed are bright frames, and frames in which images are displayed according to display data to which conversion characteristics shown by “B” in FIG. 4 are performed are dark frames. Generally, static luminance T varies according to liquid crystal applied voltage V in the liquid crystal display panel, and there exist Tmin at which the luminance is minimum and Tmax at which the luminance is maximum.

The conversion algorithm in the embodiment realizes visual luminance corresponding to input display data by combining bright frames with dark frames under the conditions that the dark frames obtain dynamic luminance to be the Tmin of the liquid crystal display panel as much as possible and that the static luminance in the case of the 255 gray-scale level when input display data is brightest is equal to Tmax.

As the dynamic luminance of the dark frame is smaller, and the range in which the dynamic luminance is small is larger, the moving picture blur can be reduced. Therefore, it is preferable that the dark frame is Tmin, however, it may be the luminance a little higher than Tmin. The range in which the dynamic luminance of the dark frame is Tmin is the range from the “0” gray scale to a gray scale of input display data corresponding to visual luminance obtained by taking Tmax as the dynamic luminance of the bright frame and taking Tmin as the dynamic luminance of the dark frame. However, the range may be extended to a gray scale a little smaller than the gray scale of input display data corresponding to visual luminance obtained by taking Tmax as the dynamic luminance of the bright frame and taking Tmin as the dynamic luminance of the dark frame.

In addition, the range in which the dynamic luminance of the bright frame is Tmax is the range from a gray scale of input display data corresponding to visual luminance obtained by taking Tmax as the dynamic luminance of the bright frame and taking Tmin as the dynamic luminance of the dark frame to the 255 gray scale. However, the range may be from the gray scale a little smaller than the gray scale of input display data corresponding to visual luminance obtained by taking Tmax as the dynamic luminance of the bright frame and taking Tmin as the dynamic luminance of the dark frame.

It is preferable that the luminance difference between respective gray scales in the display is approximately equal in human vision, and the relation between display data D and the static luminance T for driving liquid crystal is generally designed so as to satisfy a so-called gamma curve in the following formula (1) in the case of 255 gray scales.

(static luminance T)=(liquid crystal drive data D/255) (1)

It is common that γ=2.2 is used, therefore, the following explanation will be made as γ=2.2.

Assume that both rising time Tr and falling time Tf of the liquid crystal display panel 1 are “0”, the display luminance can be approximated as shown by the following formula (2).

Display luminance=(static luminance T of bright frame)/2+(static luminance T of dark frame)/2 (2)

Assume that the input display data is Din, display data of the bright frame is Dlight, and display data of the dark frame is Ddark, the following formula (3) is derived from the formula (1) and the formula (2) when γ=2.2, and characteristics shown by solid lines in FIG. 4 can be obtained.

$$Dlight = \{ \begin{matrix}{2}^{\hat{}} ( 1 / 2.2 ) * Din & when {2}^{\hat{}} ( 1 / 2.2 ) * Din < 255 \\ 255 & when {2}^{\hat{}} ( 1 / 2.2 ) * Din \geq 255\end{matrix} \\ Ddark = \{ \begin{matrix}0 & when {2}^{\hat{}} ( 1 / 2.2 ) * Din < 255 \\ 255 * {\{ 2 * {( Din / 255 )}^{\hat{}} 2.2 - 1 \}}^{\hat{}} ( 1 / 2.2 ) & when {2}^{\hat{}} ( 1 / 2.2 ) * Din \geq 255\end{matrix} \qquad ( 3 )$$

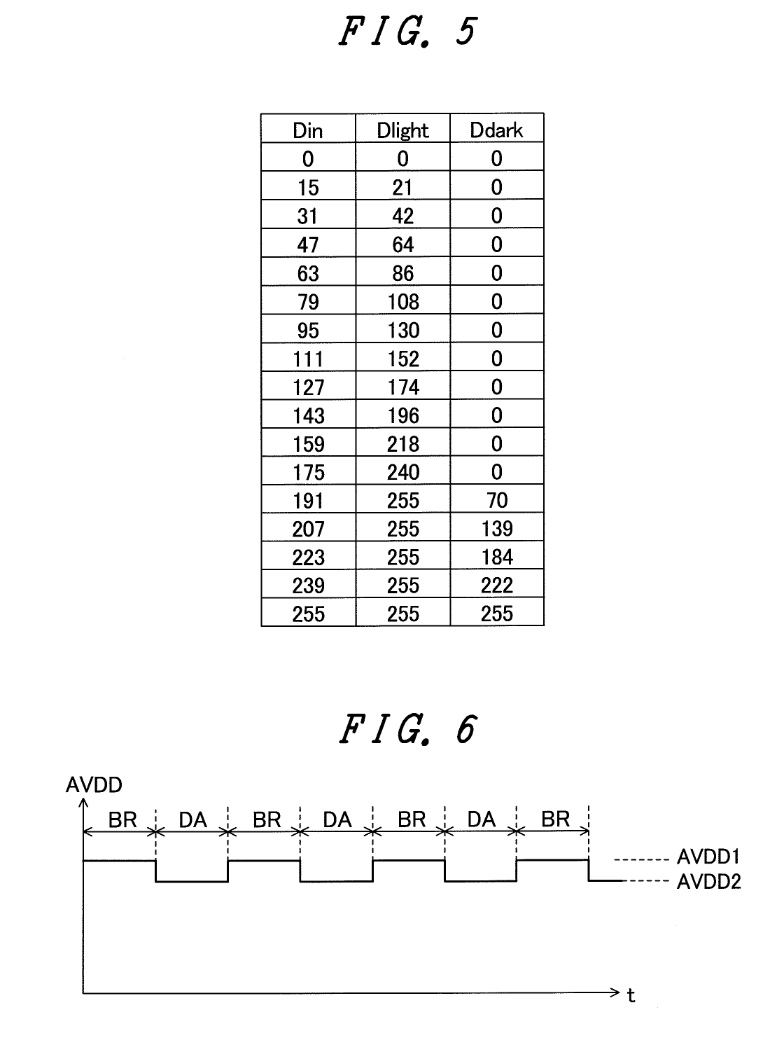

It is not always necessary that the look-up tables 216, 217 have table values with respect to all input display data (Din), and it is also preferable, for example, that table values of every 16 gray-scale levels are prepared as shown in FIG. 5 and conversion display data is generated by interpolation such as linear interpolation concerning gray scales therebetween, provided that the linearity between gray scales is sufficiently satisfied. According to this, the size of the conversion table can be reduced.

In the embodiment, it is characterized that voltage of analog power supply voltage of AVDD to be supplied to the drain driver 2 is different when images are displayed in bright frames and when images are displayed in dark frames in the FBI drive method.

Specifically, as shown in FIG. 6, when the analog power supply voltage to be supplied to the drain driver 2 at the time of bright frames (BR) is AVDD 1, and the analog power supply voltage to be supplied to the drain driver 2 at the time of dark frames (DA) is AVDD2, the voltage of AVDD 1 is allowed to be higher than the voltage of AVDD 2 (AVDD1>AVDD2).

When images are displayed in dark frames, video voltage (liquid crystal drive voltage) to be used is not so high as shown by the conversion characteristics of “B” in FIG. 4, therefore, there is no problem on driving when the analog power supply voltage is reduced.

For example, electric current flows at any time in the output amplifier circuit 25 even when there is no input signal. The electric current can be reduced by reducing driving voltage. Therefore, in the embodiment, power consumption in the output amplifier 25 can be suppressed and heating of the semiconductor chip included in the drain driver 2 can be suppressed as compared with the case in which analog power supply voltage having high electric potential is always supplied to the drain driver 2 as in the related art.

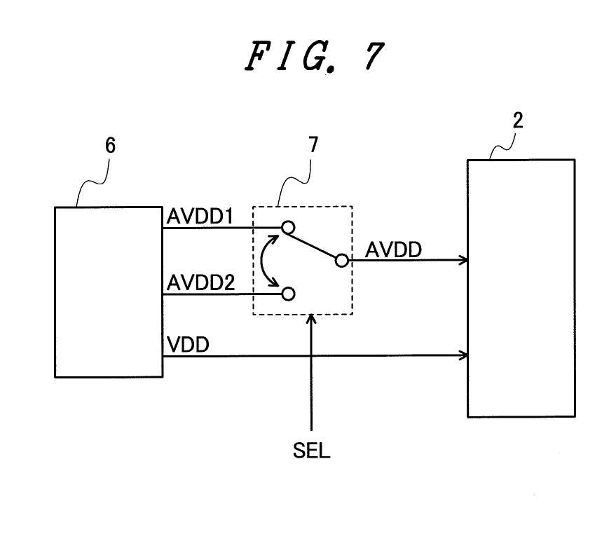

In order to switch the analog power supply voltage to be supplied to the drain driver 2, in the embodiment, the power supply circuit 5 is allowed to have analog power supply voltages of two systems which are analog power supply voltage of AVDD 1 and analog power supply voltage of AVDD 2 as shown in FIG. 7, supplying the analog power supply voltage of AVDD 1 to the drain driver 2 at the time of bright frames (BR) and supplying the analog power supply voltage of AVDD 2 to the drain driver 2 at the time of dark frames (DA) based on the selector 7 controlled by a switching signal (SEL) outputted from the timing generating circuit 51 of the display control circuit 4.

As described above, according to the embodiment, it is possible to suppress power consumption in the drain driver 2 as well as to suppress heating of the semiconductor chip included in the drain driver 2. Therefore, even when the analog power supply voltage was unable to be increased due to the heating of the semiconductor chip, the analog power supply voltage can be increased and output voltage can be increased according to the embodiment. As a result, it is possible to perform the overdrive of white luminance.

The embodiment in which the invention is applied to the liquid crystal display module has been explained in the above description, however, the invention can be applied to hold-type display devices such as an organic EL (Electro Luminescence) display or a LOCOS (Liquid Crystal On Silicon) display.

The invention made by present inventors has been specifically explained based on the embodiment as the above, and it goes without saying that the invention is not limited to the above embodiment but various modifications are possible within a range not departing from the gist of the invention.

What is claimed is:

1. A display device, comprising:
a display panel having plural subpixels;
a driver outputting video voltages corresponding to display data inputted from an external system to respective subpixels; and
a power supply circuit supplying a first power supply voltage to the driver, and
wherein each subpixel displays one gray scale required by the external system by displaying two gray scales which are a gray scale corresponding to first display data during one frame period of continuous two frame periods and a gray scale corresponding to second display data during the other frame period of the continuous two frame periods,
wherein the driver outputs a first video voltage corresponding to the first display data to each subpixel during one frame period of continuous two frame periods and outputs a second video voltage corresponding to the second display data to each subpixel during the other frame period of continuous two frame periods,
wherein the luminance according to the second display data is lower than the luminance according to the first display data when the display data inputted from the external system is in a halftone gray scale, and
wherein the power supply circuit supplies high-potential first power supply voltage to the driver during the first frame period and supplies low-potential first power supply voltage having the potential lower than the high-potential first power supply voltage during the second frame period.

2. The display device according to claim 1,
wherein the power supply circuit includes a first terminal outputting the high-potential first power supply voltage and a second terminal outputting the low-potential first power supply voltage, further comprising:
a selector selecting the high potential first power supply voltage outputted from the first terminal or the low-potential first power supply voltage outputted from the second terminal and supplies the voltage to the driver; and
a control circuit controlling the selector.

3. The display device according to claim 2,
wherein the control circuit switches the selector during a vertical blanking period, changing first power supply voltage supplied to the driver to the high-potential first power supply voltage or the low-potential first power supply voltage.

4. The display device according to claim 1, further comprising:
a first conversion circuit and a second conversion circuit, and
wherein the first conversion circuit converts display data A inputted from the external system into the first display data, and
wherein the second conversion circuit converts display data B inputted from the external system into the second display data.

5. The display device according to claim 4,
wherein the display data A and the display data B are the same data.

6. The display device according to claim 1,
wherein, when a gray scale required by the external system is included in a low gray scale side in halftone gray scales between the maximum gray scale and the minimum gray scale, the gray scale of the one frame period varies according to the gray scale required by the external system and the gray scale of the other frame period is the minimum gray scale, and
wherein, when a gray scale required by the external system is included in a high gray scale side in halftone gray scales, the gray scale of the one frame period is the maximum gray scale and the gray scale in the other frame period varies according to the gray scale required by the external system.

7. The display device according to claim 6,
wherein, when a gray scale required by the external system is the maximum gray scale, both gray scales in the one frame period and the other frame period are the maximum gray scale.

8. The display device according to claim 6,
wherein a boundary between the low gray scale side and the high gray scale side of the gray scale required by the external system is the gray scale obtained by taking one of two gray scales in continuous two frame periods as the minimum gray scale and taking the other thereof as the maximum gray scale.
